(19) United States
(12) Patent Application Publication
(10) Pub. No.: US 2012/0299387 A1
(43) Pub. Date: Nov. 29, 2012

(54) DIAGNOSTICS OF INTEGRATED SOLAR POWER

(75) Inventor: Afshin Izadian, Indianapolis, IN (US)

(73) Assignee: INDIANA RESEARCH & TECHNOLOGY CORPORATION, Indianapolis, IN (US)

(21) Appl. No.: 13/481,199

(22) Filed: May 25, 2012

Related U.S. Application Data
(60) Provisional application No. 61/490,673, filed on May 27, 2011.

(51) Int. Cl. H02J 4/00

(52) U.S. Cl. 307/97

(57) ABSTRACT

A method for detecting faults in a solar cell includes measuring at least one operational parameter of a solar cell, measuring an output of the solar cell, identifying differences between the measured output of the solar cell and estimated outputs of a first and second model of operating modes of the solar cell, generating probabilities corresponding to the likelihood that each model corresponds to the actual operating mode of the solar call based on the identified differences, and disconnecting the output of the solar cell from a load in response to the identified current operating mode being the operating mode of the second model.

### CLAIM OF PRIORITY

This patent claims priority to U.S. provisional patent application Ser. No. 61/490,673, which was filed on May 27, 2011, and is entitled “DIAGNOSTICS OF INTEGRATED SOLAR POWER,” the entire disclosure of which is expressly incorporated by reference herein.

### TECHNICAL FIELD

The present description generally relates to power generation and particularly to power generation by solar photovoltaic and power electronic converters.

### BACKGROUND

In recent years, due to growing global energy needs, sources of energy alternative to fossil fuel have gained significant popularity. One such energy source has been solar power that converts energy emitted by the sun into electricity and other useful forms of energy. One common device for converting solar energy into electricity is the photovoltaic (PV) solar cell. In one common form, a PV cell includes a semiconductor material, such as silicon, that is configured to form a p-n junction. Photons present in solar energy strike the solar cell, and photons having energy levels that exceed a band gap of the material forming the solar cell liberate electrons from the silicon atoms. A silicon atom with a missing electron has a positive charge referred to as a “hole.” The electrons and holes seek to recombine in the solar cell, and the recombination process generates an electrical voltage and current that can be used in electrical power generation.

An individual PV solar cell typically produces an output voltage of approximately 0.5-0.6 V and an output current of approximately 1.0-2.0 A when exposed to strong sunlight. In most commercial embodiments, many individual PV solar cells are arranged in a single panel and are electrically connected together to enable the panel to generate a greater amount of electrical power. Larger solar power generation facilities typically incorporate solar power arrays that include many panels with the entire facility employing thousands or even millions of the individual PV cells. Large scale solar power generation facilities can cover multiple hectares or even multiple square kilometers of land with PV solar panels.

Many solar power generation systems include a power converter that is electrically connected to one or more solar panels. The power converter is used to condition and regulate the electrical power supplied by the panels into an electrical power useful for powering various devices or for transmission via a power grid. Typical PV panels produce direct current (DC) electrical power. One type of power converter converts the DC power supplied by the PV panel into an alternating current (AC) form that is supplied to an electrical grid for delivery to remote locations or the AC current may be directly connected to one or more commonly used electrical appliances to operate the appliances.

One challenge to continued growth in the field of solar power concerns monitoring of a large number of PV panels and power converter units that are electrically connected to a large power distribution network, such as the electrical grid. Large-scale solar power generation facilities include monitoring equipment that is designed to detect and compensate for panel failures, power surges, brown-outs, and other negative events that could ramify beyond the solar power generation facility and have negative effects on the larger electrical grid. In contrast, micro-generation of solar power involves connecting a much larger number of small solar power generation facilities to the electrical grid. Examples of micro-generation facilities include residential solar power installations that typically include tens or hundreds of square meters of solar panels. Micro-generation facilities often sell excess electrical power to an electrical utility company. Existing monitoring systems are not equipped to identify that occur in micro-generation solar power systems quickly and accurately. Additionally, the costs associated with existing monitoring systems present a barrier to their use with micro-generation systems. Consequently, improvements to monitoring of solar power generation systems that enable fast diagnosis of faults without requiring extensive monitoring equipment would be beneficial.

### SUMMARY

In one embodiment, a method for identifying operational modes of a solar power system has been developed. The method includes measuring at least one operational parameter of a solar cell, measuring an output of the solar cell, generating a first estimated output for the solar cell with reference to a first model of the solar cell operating in a first operating mode with the at least one operational parameter, generating a second estimated output for the solar cell with reference to a second model of the solar cell operating in a second operating mode with the at least one operational parameter, generating a first probability value that the solar cell is operating in the first operating mode, the first probability value being generated with reference to the first estimated output of the solar cell and a difference between the first estimated output of the solar cell and the measured output of the solar cell, generating a second probability value that the solar cell is operating in the second operating mode, the second probability value being generated with reference to the second estimated output of the solar cell and a difference between the second estimated output of the solar cell and the measured output of the solar cell, identifying a current operating mode of the solar cell as being only one of the first operating mode or the second operating mode, the current operating move being identified with reference to a previous operating mode, the first probability value, and the second probability value, and disconnecting the output of the solar cell from a load in response to the identified current operating mode being the second operating mode.

In another embodiment a method for identifying operating modes of a solar power system has been developed. The method includes measuring at least one operational parameter of a solar cell, measuring an output of the solar cell, measuring at least one operational parameter of a power converter that is electrically connected to the solar cell, measuring an output of the power converter, generating a first estimated output for the solar cell with reference to a first model of the solar cell operating in a first operating mode with the at least one operational parameter of the solar cell, generating a second estimated output for the solar cell with reference to a second model of the solar cell operating in a second operating mode with the at least one operational parameter of the solar cell, generating a first probability value that the solar cell is operating in the first operating mode, the first probability value being generated with reference to the first estimated output of the solar cell and a difference between the first estimated output of the solar cell and the measured output of the solar cell, generating a second probability value that the solar cell is operating in the second operating mode, the second probability value being generated with reference to the second estimated output of the solar cell and a difference between the second estimated output of the solar cell and the measured output of the solar cell, identifying a current operating mode of the solar cell as being only one of the first operating mode or the second operating mode, the current operating move being identified with reference to a previous operating mode, the first probability value, and the second probability value, generating a plurality of estimated outputs for the power converter with reference to a corresponding plurality of models of the power converter, each model in the plurality of models corresponding to one operating mode in a plurality of operating modes of the power converter, generating a plurality of probability values, each probability value in the plurality of probability values being a probability that the power converter is operating in one of the plurality of operating modes of the power converter, each probability value being generated with reference to a corresponding one of the plurality of estimated outputs of the power converter and a difference between the one estimated output and the measured output of the power converter, identifying a current operating mode of the power converter with reference to a previous operating mode, and each of the plurality of probability values, comparing the identified current operating mode of the power converter to an expected operating mode of the power converter with reference to a predetermined number of power converter operating modes having a predetermined order, and disconnecting the output of the power converter from a load in response to at least one of the identified current operating mode of the solar cell being the second operating mode or the identified current operating mode of the power converter being different from the expected operating mode.

### BRIEF DESCRIPTION OF THE DRAWINGS

FIG. 1 is a schematic diagram of a solar power generation system that is configured to be monitored for faults during operation.

FIG. 2 is a diagram of a multiple-model adaptive estimation system that is implemented by the system of FIG. 1 to perform fault detection.

FIG. 3A is a circuit diagram that describes operation of a solar cell in one operating mode.

FIG. 3B is a circuit diagram that describes operation of a solar cell in another operating mode.

FIG. 4A is a circuit diagram for a power converter that is configured to switch between a plurality of states.

FIG. 4B is a circuit diagram that describes the operation of the power converter of FIG. 4A in a first state.

FIG. 4C is a circuit diagram that describes the operation of the power converter of FIG. 4A in a second state.

FIG. 4D is a circuit diagram that describes the operation of the power converter of FIG. 4A in a third state.

### DETAILED DESCRIPTION

For a general understanding of the environment for the system and method disclosed herein as well as the details for the system and method, reference is made to the drawings. In the drawings, like reference numerals have been used throughout to designate like elements. As used herein, the term “operational parameter” refers to a physical property of a circuit or component in a solar power system that can be measured while the component operates. For example, a series resistance value in an individual solar cell is an operational parameter of the solar cell. Various components in the solar power system have one or more operational parameters that may be monitored during operation. As used herein, the term “operating mode” refers to a set of operating characteristics that apply to a component in a solar power system based on the conditions of the component. For example, during a normal operating mode a solar cell generates electrical voltage and current with known parameters when exposed to sunlight. The characteristics of the solar cell in the normal operating mode are modeled to enable an estimate of an output of the solar cell, such as an output voltage or current, when one or more of the operational parameters of the solar cell are measured. One or more failure modes for the solar cell include operational modes where the operational parameters and corresponding output of the solar deviate from the expected output in the normal operating mode. Systems and methods that identify changes in the operational modes of components in a solar power system, particularly failure modes, are described in more detail below.

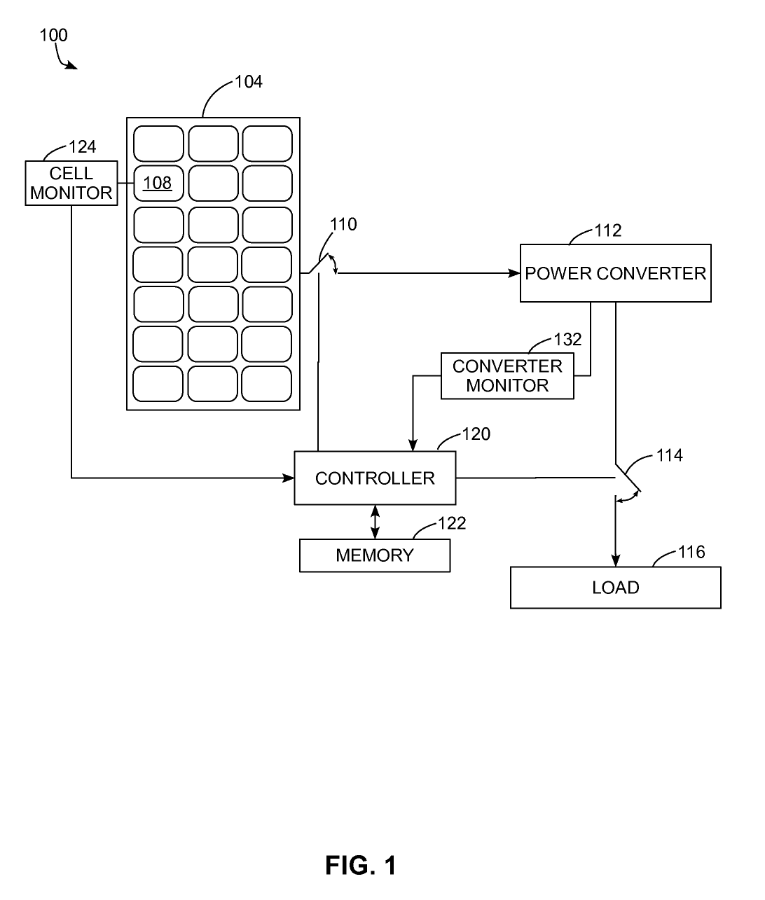

FIG. 1 depicts a solar power generation system 100. The system 100 includes a solar panel 104 that includes a plurality of solar cells, such as solar cell 108, a power converter 112, and controller 120. A solar cell monitoring device 124 is operatively connected to the solar cell 108 and the controller 120. A power converter monitoring device is operatively connected to the power converter 112 and the controller 120. The solar cells 108 in the panel 104 generate direct current (DC) electricity in response to light shining on the solar cells. The solar cells 108 of the panel 104 are electrically connected together to output the DC current to the power converter 112. An electrical power output of the power converter 112 is electrically connected to a load 116. Typical embodiments of the power converter 112 include inverters that generate an alternating current from the direct current generated by the panel 104. Other embodiments of the power converter 112 include DC to DC power boosters. Typical embodiments of the load 116 include batteries, electrical appliances, and the electric grid. In one configuration the power converter 112 is a separate device from the panel 104, while some solar panel embodiments include one or more power converters that are integrated with the panel. While FIG. 1 depicts a single solar panel 104, alternative configurations include multiple solar panels that provide electrical current to one or more power converters. The fault detection methods described herein are suitable for use with the various configurations of solar cells, panels, and power converters.

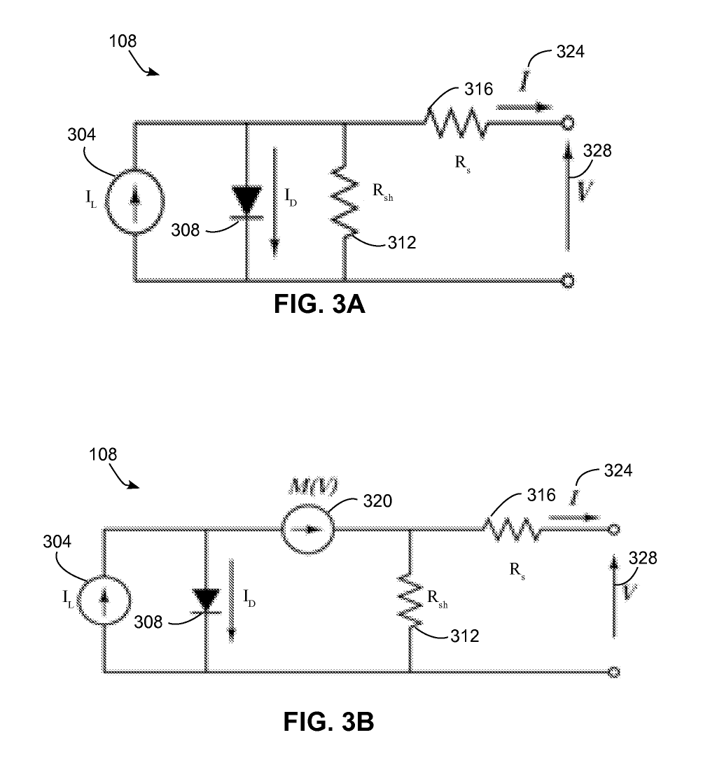

Cell monitor 124 is configured to measure at least one operational parameter of a single solar cell 108 as well as an output of the solar cell 108 and provide data corresponding to the measurement to the controller 120. FIG. 3A and FIG. 3B depict circuit diagrams that model operation of a solar cell in two different operating modes. Both models of faulty power converter include a current source 304 and diode 308 that are connected in parallel with a shunt resistance Rₛₕ 313 and in series with a series resistance Rₛ 316. FIG. 3B additionally includes a voltage controlled current source 320 that can model an avalanche effect that occurs due to the solar cell being placed in a shadow. Both models for the solar cells in FIG. 3A and FIG. 3B depict an output current I 324 and output voltage V 328.

Examples of operational parameters in a solar cell include a series resistance Rₛ 312, a shunt resistance Rₛₕ, and in the case of FIG. 3B, a voltage controller current source M(V) 320. The cell monitor 124 is configured to measure some or all of the operational parameters during operation of the solar cell 108. Of course, the circuit components depicted in the diagrams 3A and 3B are models of a solar cell, and typical solar cells do not include discrete resistors and other components that are depicted in the diagrams. The cell monitor 124 may measure resistance and current values that correspond to the various operational parameters using indirect measurement techniques that are known to the art.

In FIG. 3A, increases to the values of one or both of Rₛₕ 312 and Rₛ 316 above predetermined resistance values indicate that the solar cell 108 is operating in a failure mode instead of a normal operating model. In FIG. 3B, the current value of M(V) 320 can indicate a failure mode when the current source 320 generates a current that reduces or reverses the output current 324. When the current reverses, the solar cell 108 operates as a current sink instead of a current source. The solar cell monitor 124 provides data corresponding to the operating parameters of the solar cell 108 and to the actual output of the solar cell 108 to the controller 120. As described below, the controller 120 is configured to identify an operating mode of the solar cell 108 using multiple models that include the measured operational parameters and the measured output of the solar cell 108.

Referring again to FIG. 1, a converter monitor 132 is operatively connected to the power converter 112. The converter monitor is configured to measure one or more operational parameters of the power converter 112 and one or more outputs of the power converter 112. Power converters such as power converter 112 are typically modeled as being supplied by a voltage source. As the solar cells are current source devices, the solar cell affects the operation of power converter. Therefore, measurements of the operational parameters and output of the power converter 112 can be used to identify faults that occur in the power converter 112 and in the panel 108 that supplies the power converter.

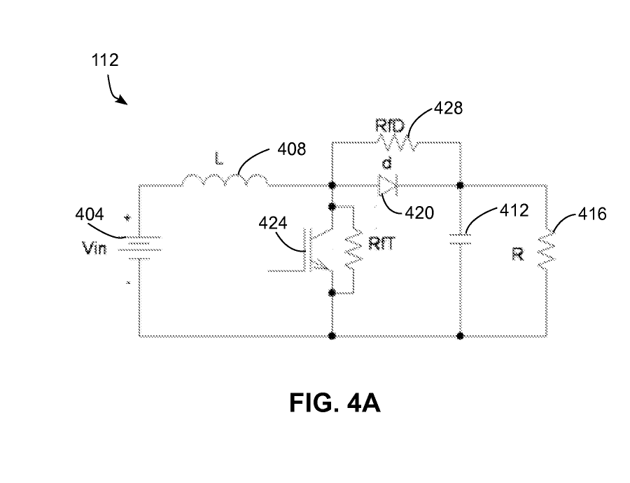

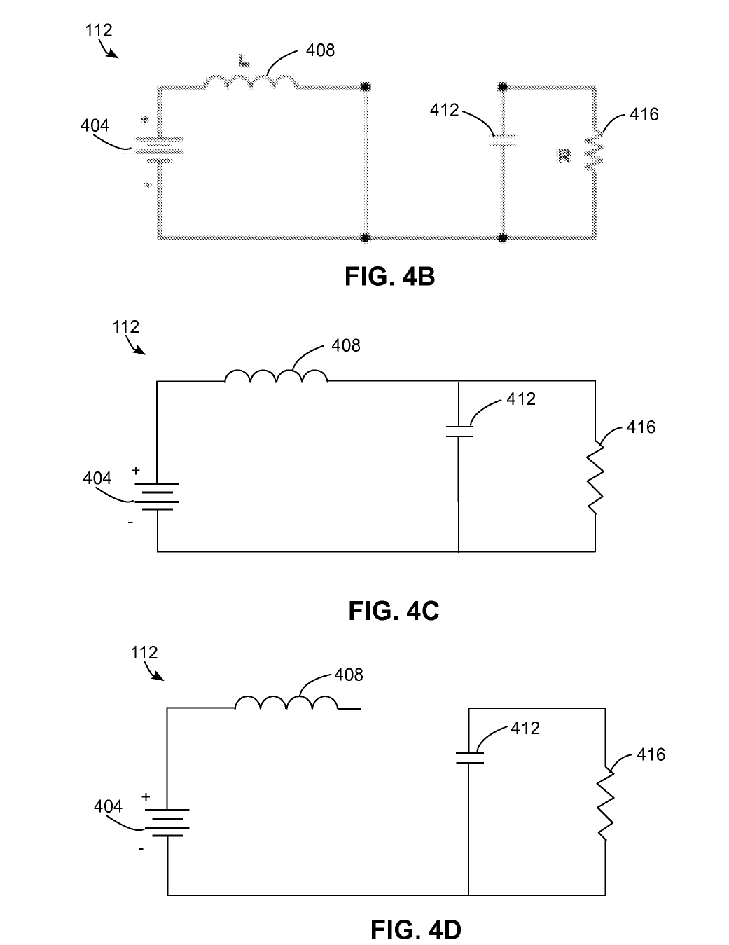

The converter monitor 132 provides data corresponding to the measured operating parameters and output of the converter 112 to the controller 120. The embodiment of the power converter 112 depicted in FIG. 1 is modeled as a circuit depicted in FIG. 4A. The circuit includes a voltage source 404, inductor 408, transistor 424, diode 420, capacitor 412 and resistor 416. A diode resistor 428 is connected in parallel with the diode 420. During normal operations, the diode resistor operates as an open circuit to enable diode 420 to control a flow of current by switching on and off in conjunction with the transistor 424. In a failure mode, however, the diode resistance 428 drops to a lower resistance value, effectively shorting the circuit around diode 420 and reducing the effectiveness of the power converter 112 or rendering the power converter 112 inoperable.

One method for identifying various operational modes of the power converter 112 includes an averaged fault diagnosis. Switching devices in electronic power circuits result in a discrete system. The topology of the circuit changes by switching the diode and transistors between “on” and “off” states. In this regard, the model requires more details and advanced techniques for fault diagnosis. Probability density evaluation and simulation for a predefined set of faults was conducted to prove the performance of fault diagnosis in simulations. More details of the averaged fault diagnosis method are described in the attached appendix.

Another method for identifying various operating modes of the power converter 112 includes modeling the power converter 112 as a switched circuit. During normal operation, the power converter 112 cycles between three circuit configurations that are depicted in FIG. 4B-FIG. 4D. The three circuits can be modeled as three operating modes that describe the operation of the power converter 112 during the operating cycle.

FIG. 4B, FIG. 4C, and FIG. 4D depict three circuit configurations that depict the operating modes for the circuit depicted in FIG. 4A during normal operation. FIG. 4B depicts the circuit of FIG. 4A with diode 420 in an open state and transistor 424 in a closed state. FIG. 4C depicts the circuit of FIG. 4A with both the diode 420 and transistor 424 in a closed state. FIG. 4D depicts the circuit of FIG. 4A with both the diode 420 and transistor 424 in an open state. During normal operation, the power converter 112 cycles in order between the states of FIG. 4B-4D at a predetermined frequency. The power converter monitor 132 is configured to identify the operational parameters of one or more components in the power converter, including the resistances of the transistor 424 and diode 420, during operation of the power converter and to provide data corresponding to the operational parameters to the controller 120. The power converter monitor 132 is also configured to measure an output current and voltage from the power converter and provide data corresponding to the measured output to the controller 120.

Referring again to FIG. 1, the controller 120 is configured to receive data from one or both of the cell monitor 124 and converter monitor 132 and to identify operating modes of the solar cells 108 and power converter 112. Controller 120 may be implemented with general or specialized programmable processors that execute programmed instructions. The instructions and data required to perform the programmed functions may be stored in memory associated with the processors or controllers. These components may be provided on a printed circuit card or provided as a circuit in an application specific integrated circuit (ASIC). Each of the circuits may be implemented with a separate processor or multiple circuits may be implemented on the same processor. Alternatively, the circuits may be implemented with discrete components or circuits provided in VLSI circuits. Also, the circuits described herein may be implemented with a combination of processors, ASICs, discrete components, or VLSI circuits. Controller 120 is operatively connected to a memory 122. The memory 122 stores program instructions for execution by the controller 120. The memory 122 also stores data corresponding to previously identified operational parameters, operating modes, and outputs of the solar cells 108 and power converter 112.

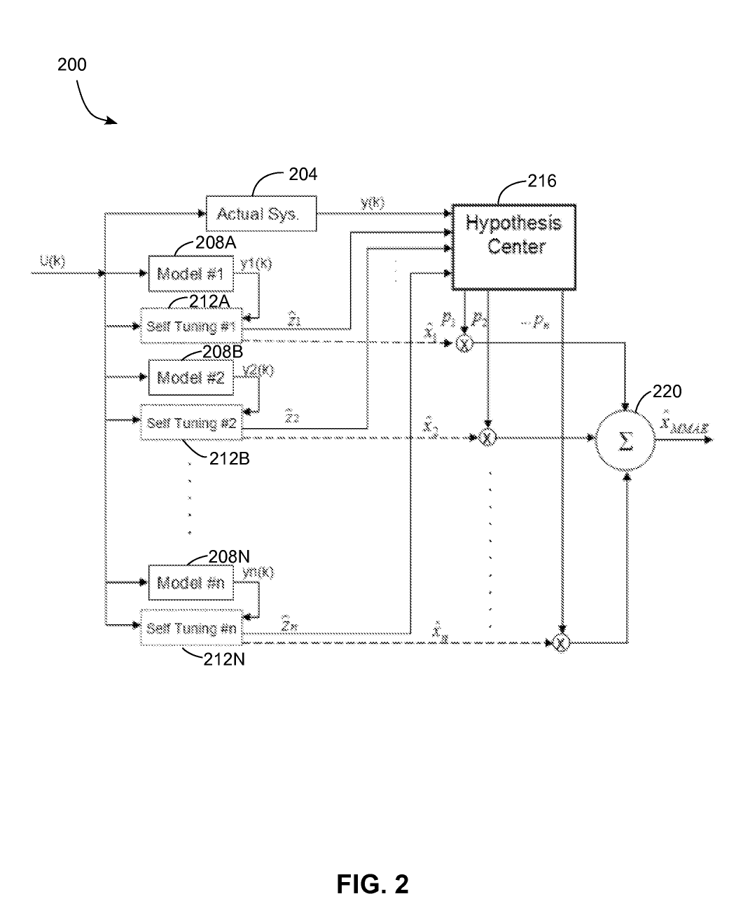

The controller 120 is configured to identify the operating modes of the solar cells 108 and power converter 112 using a multiple-model adaptive estimator (MMAE). FIG. 2 depicts an exemplary MMAE system 200. In general, an MMAE system compares predicted outputs from two or more models to an actual measured output of a system for a given input. In FIG. 2, the input U(k) is supplied to a plurality of models 208A-208N. Each of the models 208A-208N represents a model of a system, such as the solar cell 108 or power converter 112, in a particular operating mode. The output of the actual system 204 y(k), such as an electrical output signal, is also measured. The estimated output of each of the models 208A-208N is compared to the actual output producing residual signals. The residual signals refer to differences between an observed output value from the actual system 204 and the estimated outputs from the models 208A-208N. Thus, residual signals with zero magnitude indicate that an output of the actual system 204 matches an estimated output of a corresponding model.

In the MMAE system 200, the hypothesis center 216 weights the outputs of each of the models 208A-208N based on the current residual signal identified for the model, and also with reference to a prior history of residual signal differences between the actual output from the system 204 and the estimated output from each of the models 208A-208N. The prior history of residual errors used in the hypothesis center 216 enables the MMAE system 200 to weight the values of models based not only on the currently measured residual signal values, but on previous residual signals. In one exemplary configuration, model 208B has a current residual signal value of zero, but has a history of residual values with large magnitudes, while model 208A has a non-zero current residual signal value with a history of low or zero magnitude residual signal values. The hypothesis center 216 weights the output of model 208A more heavily even though the current residual signal value for the model 208A is greater than the residual signal value for model 208B based on the historic residual signal values for both models.

MMAE systems, such as system 200, often include various filters, including Kalman filters, to compensate for noise in the input U(k) and in the corresponding outputs from the models 208A-208N and from the system 204. The exemplary MMAE system 200 additionally includes self-tuning modules 212A-212N. Each of the self-tuning modules 212A-212N is configured to adjust a corresponding one of the models 208A-208N to account for changes in the operating parameters in each model that may occur over time. Examples of changes in an operating parameter for a model that occur over time include changes to internal resistance of a solar cell, or changes to the switching characteristics of the power converter. Thus, the self-tuning modules 212A-212N are configured to selectively discount or “forget” prior residual signal values when the operating parameters of a selected model change over time. The self-tuning modules 212A-212N enable the MMAE system 200 to compensate for changes in the operating parameters of the actual system 204 in each of the models 208A-208N. The tuning modules 212A-212N may employ various algorithms, including the forgetting-factor recursive least square (FFRLS) algorithm. The hypothesis center 216 selectively discounts the weight of historic residual signal values from each of the models 208A-208N based on the tuning values generated by each of the self-tuning modules 212A-212N.

The hypothesis center 216 generates a plurality of probability values that are assigned to each of the models 208A-208N. Each probability value indicates a probability that the actual system 204 is presently operating in an operating mode that corresponds to each one of the models 208A-208N. The MMAE system 200 generates a probability distribution 220 with probability values assigned to each of the models 208A-208N. In one configuration, the controller 120 identifies the model having the highest probability value in the distribution 220 as the current operating mode of the actual system 204. As described in more detail in the attached appendix, the MMAE system 200 is configured to identify changes in the operating mode of the solar cells 108 and power converter 112 in the system 100 using a small number of data samples. Thus, the controller 120 is configured to identify and take appropriate action in a short time period when transient faults occur.

In operation, the solar cells 108 in the solar panel 104 generate electricity that is supplied to the power converter 112 and subsequently to the load 116. The controller 120 receives operating data and output data from the cell monitor 108 and applies the data to an MMAE system. Controller 120 employs circuit models, such as the circuit models depicted in FIG. 3A and FIG. 3B as models in the MMAE system. In situations where the controller 120 identifies that the operating mode of the solar cell 108 and the power converter combined corresponds to a failure mode, the controller 120 is configured to open a panel switch 110 that electrically isolates the panel 104 from the power converter 112. Since many fault conditions are transient in nature and last only for a short period of time, the controller 120 is also configured to close the switch 110 when the solar cell 108 returns to a normal operating mode. In an alternative configuration, each of the cells 108 may be individually coupled to an electrical switch that isolates each cell from the remaining cells in the solar panel 104.

The controller 120 is also configured to monitor the operating modes of the power converter 112. As seen in FIG. 4B-FIG. 4D, the power converter cycles between three different operating modes during normal operation. The controller 120 includes an MMAE system that incorporates the three normal operating modes as well as one or more fault modes, such as when the diode 420 disrupts the output of the converter. The controller monitors the output of the MMAE system to identify the expected cyclical changes in operating mode between the three normal operating modes for the power converter 112. The controller identifies a fault when the identified operating mode is not one of the three normal operating modes, or when the identified operating modes do not cycle with the expected operating frequency of the power converter 112. The controller 120 is configured to open the switch 114 to electrically isolate the power converter 112 from the load 116 in response to detecting the fault.

While FIG. 1 depicts controller 120 as being configured to monitor both solar cells 108 and the power converter 112, alternative configurations of the solar power generation system 100 connect the controller to either the solar cells 108 or the power converter 112. Additionally, alternative monitoring systems can monitor an entire panel, such as panel 104, instead of monitoring a single solar cell. The circuit models presented above are exemplary of models that are suitable for use with the solar cell and power converter embodiments described herein. Alternative components and configurations used in solar power generation systems include different circuit models that correspond to normal operating modes and failure modes associated with each alternative configuration.

In various configurations, the controller 120 performs actions in addition to or instead of operating the switches 110 and 114 when a fault operating mode is identified. In one configuration, the controller 120 generates a record of the failure, including information, such as the time and duration of the failure, and stores the record in the memory 122. Some embodiments of the controller 120 include a networking module (not depicted) that transmits alerts or records of faults via wired or wireless data networks to a remote computing device for further monitoring and diagnostics.

While the embodiments have been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A method of identifying operational modes in a solar power system comprising:
measuring at least one operational parameter of a solar cell;
measuring an output of the solar cell;
generating a first estimated output for the solar cell with reference to a first model of the solar cell operating in a first operating mode with the at least one operational parameter;
generating a second estimated output for the solar cell with reference to a second model of the solar cell operating in a second operating mode with the at least one operational parameter;
generating a first probability value that the solar cell is operating in the first operating mode, the first probability value being generated with reference to the first estimated output of the solar cell and a difference between the first estimated output of the solar cell and the measured output of the solar cell;
generating a second probability value that the solar cell is operating in the second operating mode, the second probability value being generated with reference to the second estimated output of the solar cell and a difference between the second estimated output of the solar cell and the measured output of the solar cell;
identifying a current operating mode of the solar cell as being only one of the first operating mode or the second operating mode, the current operating move being identified with reference to a previous operating mode, the first probability value, and the second probability value; and
disconnecting the output of the solar cell from a load in response to the identified current operating mode being the second operating mode.

2. The method of claim 1, the at least one operational parameter of the solar cell further comprising:
a series resistance; and
a parallel resistance.

3. The method of claim 2, the output of the solar cell being an output voltage.

4. The method of claim 1, the at least one operational parameter of the solar cell further comprising:
an electrical current generated by a voltage controlled current source in the solar cell.

5. The method of claim 4, the output being an output electrical current of the solar cell.

6. The method of claim 1 further comprising:
measuring at least one operational parameter of a power converter that is electrically connected to the load between the output of the solar cell and the load;
measuring an output of the power converter;
generating a plurality of estimated outputs for the power converter with reference to a corresponding plurality of models of the power converter, each model in the plurality of models corresponding to one operating mode in a plurality of operating modes of the power converter;
generating a plurality of probability values, each probability value in the plurality of probability values being a probability that the power converter is operating in one of the plurality of operating modes, each probability value being generated with reference to a corresponding one of the plurality of estimated outputs of the power converter and a difference between the one estimated output of the power converter and the measured output of the power converter;
identifying a current operating mode of the power converter with reference to a previous operating mode, and each of the plurality of probability values;
comparing the identified current operating mode of the power converter to an expected operating mode with reference to a predetermined number of power converter operating modes having a predetermined order; and
disconnecting the output of the power converter from the load in response to the identified current operating mode of the power converter being different than the expected operating mode.

7. The method of claim 6, the at least one operational parameter of the power converter further comprising:
an effective resistance of a diode in an off state.

8. The method of claim 6, the output of the power converter being an output voltage.

9. A method of identifying operational modes in a solar power system comprising:
measuring at least one operational parameter of a solar cell;
measuring an output of the solar cell;
measuring at least one operational parameter of a power converter that is electrically connected to the output of the solar cell;
measuring an output of the power converter;
generating a first estimated output for the solar cell with reference to a first model of the solar cell operating in a first operating mode with the at least one operational parameter of the solar cell;
generating a second estimated output for the solar cell with reference to a second model of the solar cell operating in a second operating mode with the at least one operational parameter of the solar cell;
generating a first probability value that the solar cell is operating in the first operating mode, the first probability value being generated with reference to the first estimated output of the solar cell and a difference between the first estimated output of the solar cell and the measured output of the solar cell;
generating a second probability value that the solar cell is operating in the second operating mode, the second probability value being generated with reference to the second estimated output of the solar cell and a difference between the second estimated output of the solar cell and the measured output of the solar cell;
identifying a current operating mode of the solar cell as being only one of the first operating mode or the second operating mode, the current operating move being identified with reference to a previous operating mode, the first probability value, and the second probability value;
generating a plurality of estimated outputs for the power converter with reference to a corresponding plurality of models of the power converter, each model in the plurality of models corresponding to one operating mode in a plurality of operating modes of the power converter;
generating a plurality of probability values, each probability value in the plurality of probability values being a probability that the power converter is operating in one of the plurality of operating modes of the power converter, each probability value being generated with reference to a corresponding one of the plurality of estimated outputs of the power converter and a difference between the one estimated output and the measured output of the power converter;
identifying a current operating mode of the power converter with reference to a previous operating mode, and each of the plurality of probability values;
comparing the identified current operating mode of the power converter to an expected operating mode of the power converter with reference to a predetermined number of power converter operating modes having a predetermined order; and
disconnecting the output of the power converter from a load in response to at least one of the identified current operating mode of the solar cell being the second operating mode or the identified current operating mode of the power converter being different from the expected operating mode.

10. The method of claim 9, the at least one operational parameter of the solar cell further comprising:
a series resistance; and
a parallel resistance.

11. The method of claim 10, the output of the solar cell being an output voltage.

12. The method of claim 9, the at least one operational parameter of the solar cell further comprising:
an electrical current generated by a voltage controlled current source in the solar cell.

13. The method of claim 12, the output being an output electrical current of the solar cell.

14. The method of claim 9, the at least one operational parameter of the power converter further comprising:
an effective resistance of a diode in an off state.

15. The method of claim 6, the output of the power converter being an output voltage.
